(19) United States
(12) Patent Application Publication
(10) Pub. No.: US 2012/0007954 A1
(43) Pub. Date: Jan. 12, 2012

(54) METHOD AND APPARATUS FOR A DISPARITY-BASED IMPROVEMENT OF STEREO CAMERA CALIBRATION

(75) Inventors: Andrew Miller, Sanford, FL (US); Goksel Dedeoglu, Plano, TX (US)

(73) Assignee: TEXAS INSTRUMENTS INCORPORATED, Dallas, TX (US)

(21) Appl. No.: 13/150,643

(22) Filed: Jun. 1, 2011

Related U.S. Application Data
(60) Provisional application No. 61/362,471, filed on Jul. 8, 2010.

(51) Int. Cl. H04N 13/02

(52) U.S. Cl. 348/46; 348/E13.074

(57) ABSTRACT

A method and apparatus for camera calibration. The method is for disparity estimation of the camera calibration and includes collecting statistical information from at least one disparity image, inferring sub-pixel misalignment between a left view and a right view of the camera, and utilizing the collected statistical information and the inferred sub-pixel misalignment for calibration refinement.

### CROSS-REFERENCE TO RELATED APPLICATIONS

This application claims benefit of United States provisional patent application serial number 61/362,471, filed Jul. 08, 2010, which is herein incorporated by reference.

### BACKGROUND OF THE INVENTION

1. Field of the Invention

Embodiments of the present invention generally relate to a method and apparatus for a disparity-based improvement of stereo camera calibration.

2. Description of the Related Art

There is a need for precise geometric calibration between two views in a stereo camera system. Without accurate calibration, stereo algorithms estimate the depth of the scene poorly and produce spurious depth measurements and artifacts.

Image capturing devices, such as, cameras, loose calibration over time due to wear or electro-mechanical limitations. Also, cameras, sometimes, are not fully calibrated. In such cases, there is a need for a method and apparatus for improving the calibration between stereo cameras and, thereby, yielding more detailed and accurate depth images.

### SUMMARY OF THE INVENTION

Embodiments of the present invention relate to a method and apparatus for camera calibration. The method is for disparity estimation of the camera calibration and includes collecting statistical information from at least one disparity image, inferring sub-pixel misalignment between a left view and a right view of the camera, and utilizing the collected statistical information and the inferred sub-pixel misalignment for calibration refinement.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a flow diagram for a method of a stereo disparity estimation system;

FIG. 2 is an embodiment of a flow diagram for a method of an improved stereo disparity estimation system;

FIG. 3 is an embodiment depicting color images showing disparity estimation; and

FIG. 4 is an embodiment of three different stereo algorithms using three different quality metrics; and

### DETAILED DESCRIPTION

To improve the calibration between stereo cameras and, thereby, yielding more detailed and accurate depth images. This is achieved by estimating the misalignment between the views with sub-pixel accuracy and compensating against it. Such a refinement in calibration leads to drastic improvements in the quality of stereo-based depth images.

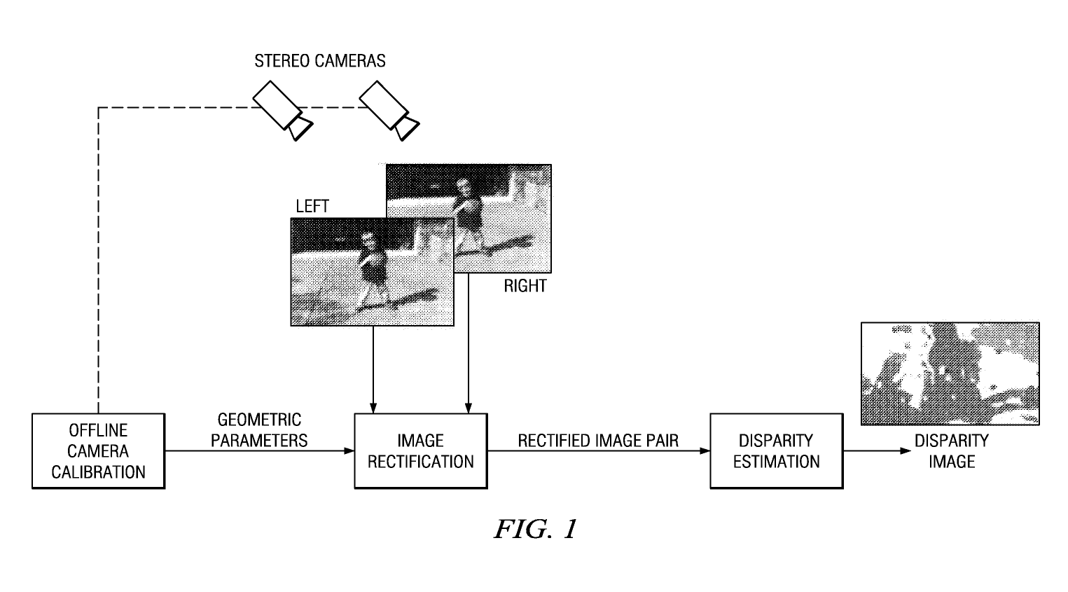

FIG. 1 is an embodiment of a flow diagram for a method of a stereo disparity estimation system. The calibration of the left/right camera pair is typically an offline process wherein the relative geometry of the cameras is captured. This calibration information is used at run-time to rectify the left/right images, ensuring that the epipolar lines correspond to the scan-lines of the cameras. This is a requirement in stereo systems, as it simplifies the correspondence problem tackled in the disparity estimation step. The three-dimensional depth of a point in the scene is inversely proportional to the disparity of that pixel.

Thus, a run-time calibration refinement procedure can improve the cameras' calibration. In some embodiments, calibration methods analyze the left/right images directly to infer the misalignment between the cameras. Alternatively, the quality of the stereo depth image can be treated as the guiding principle in deciding what the optimal alignment is between the images. In other words, one can leverage the end application (stereo depth estimation) itself towards improving its results.

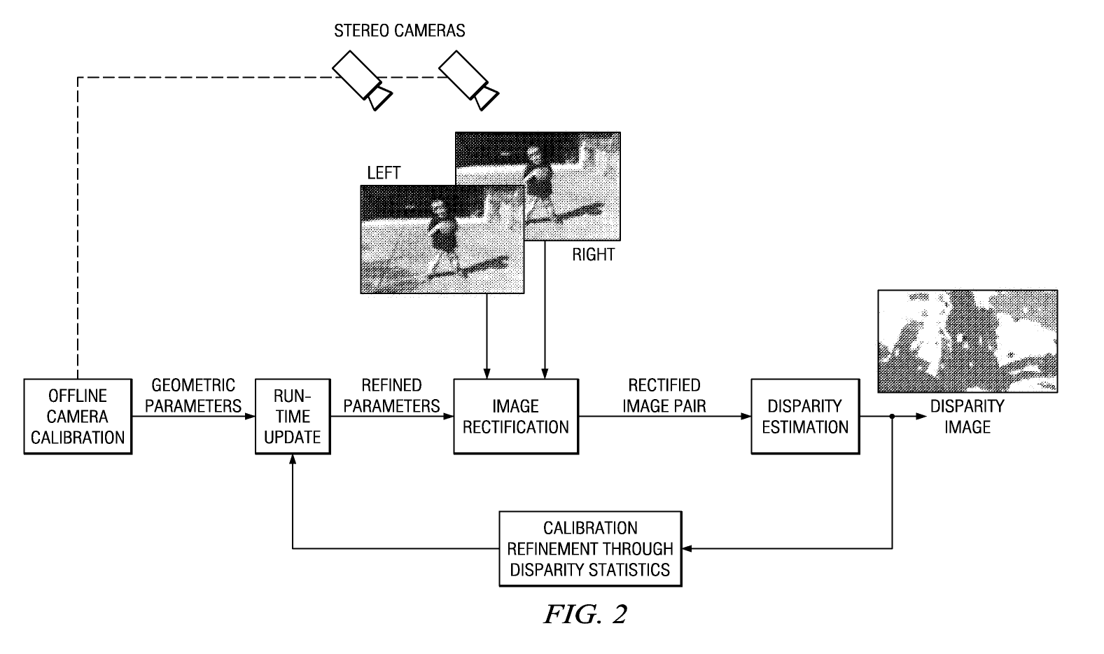

FIG. 2 is an embodiment of a flow diagram for a method of an improved stereo disparity estimation system. In FIG. 2, the typical stereo data flow of FIG. 1 is augmented with a calibration refinement loop. Statistics from the disparity image are used to infer sub-pixel misalignments between the left/right views. The method is shown to work for three different disparity estimation (stereo) algorithms, as well as, statistics. This refinement process is to be activated/applied when there is sufficient change in the calibration of the cameras.

As shown in FIG. 2, the calibration refinement process can fit into the standard stereo flow of FIG. 1. Hence, statistics derived from the disparity image is used in inferring the best calibration adjustment. Determining which particular statistics one should use and how exactly the disparity image is estimated are important, yet, not central to our claims. This point is reinforced by implementing three different quality metrics for three different stereo algorithms, and showing that our refinement process works well on all of them.

In one implementation, which is the alignment/motion model, this method is validated by considering a global vertical displacement between the left and right images. That is, in FIG. 2, the run-time update is modifying the vertical translation parameter. To find the best alignment, an exhaustive search is implemented, i.e., a set of predetermined vertical between −5.0 and 2.0 pixels at 0.25 pixel intervals is considered. In such a case, the peak of this curve as the optimal alignment value is chosen. Whereas, in disparity image statistics, three quality metrics (QM) can be implemented to determine the best alignment setting:
QM1: Density of the output—count of valid disparity image pixels.
QM2: The entropy of the valid disparity values.
QM3: Average SAD-matching score for valid disparity image pixels.

When utilizing an algorithm to search for best disparity, a method using the following three stereo algorithms (SA) is tested. These algorithms estimate the optimal disparity amount for each and every pixel in the image:
SA1: Stereo module implementation
SA2: OpenCV's SAD-based block matching implementation [4]
SA3: OpenCV's Semi-Global Matching implementation

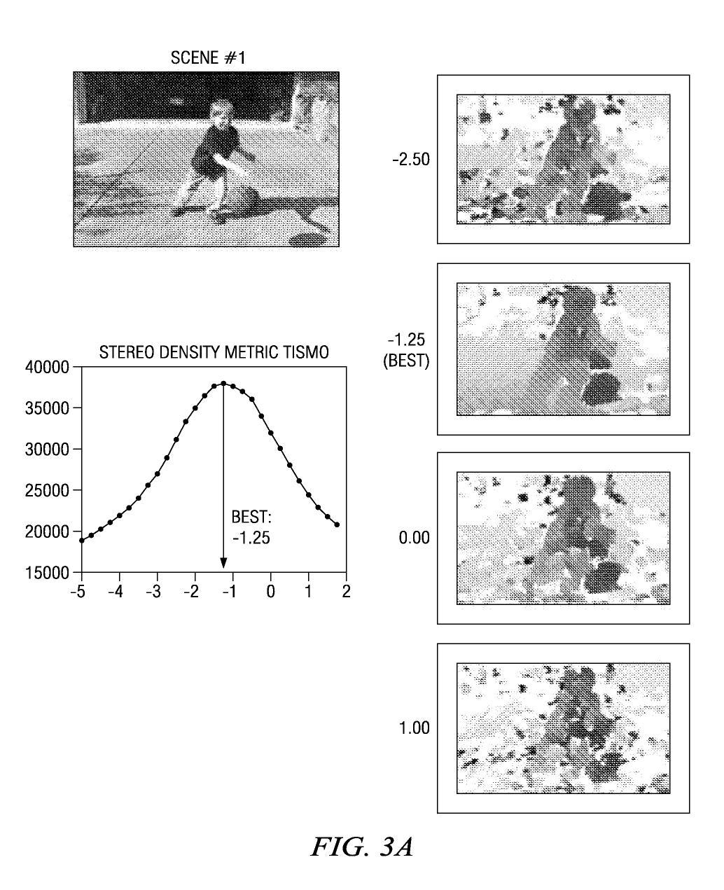

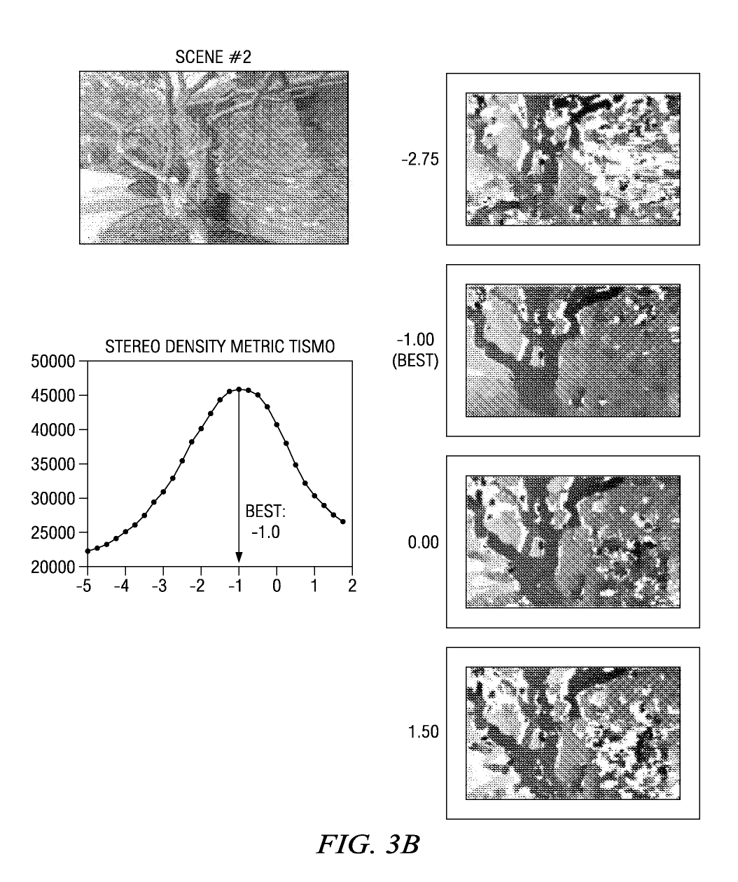

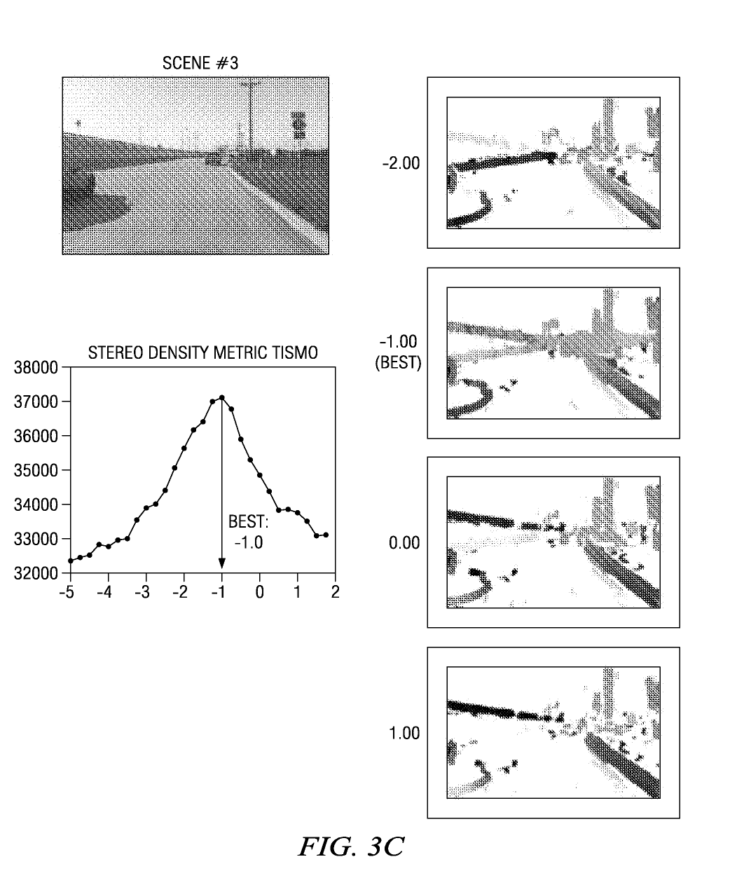

FIG. 3 is an embodiment depicting color images showing disparity estimation. In FIG. 3, compelling visual evidence is shown in three different scenes. Specifically, the disparity output images (in false color) from stereo module implementation (SA1) and the corresponding curves for the “density” quality metric (QM1) are shown. The curves on the second row are obtained by trying out different vertical displacement between the left and right views. Note that the maximizers of the quality metric curves correspond to the most consistent and clean disparity images. Without this refinement step, the algorithm would have output the row where vertical displacement is 0.

The images shown below the graphs in FIG. 3 show the disparity estimates by stereo module for different settings of the vertical displacement between the left and right views. Note how the maximizers of the quality metric curves correspond to the most correct disparity images. Without this refinement step, the algorithm would have output the row where vertical displacement is 0.

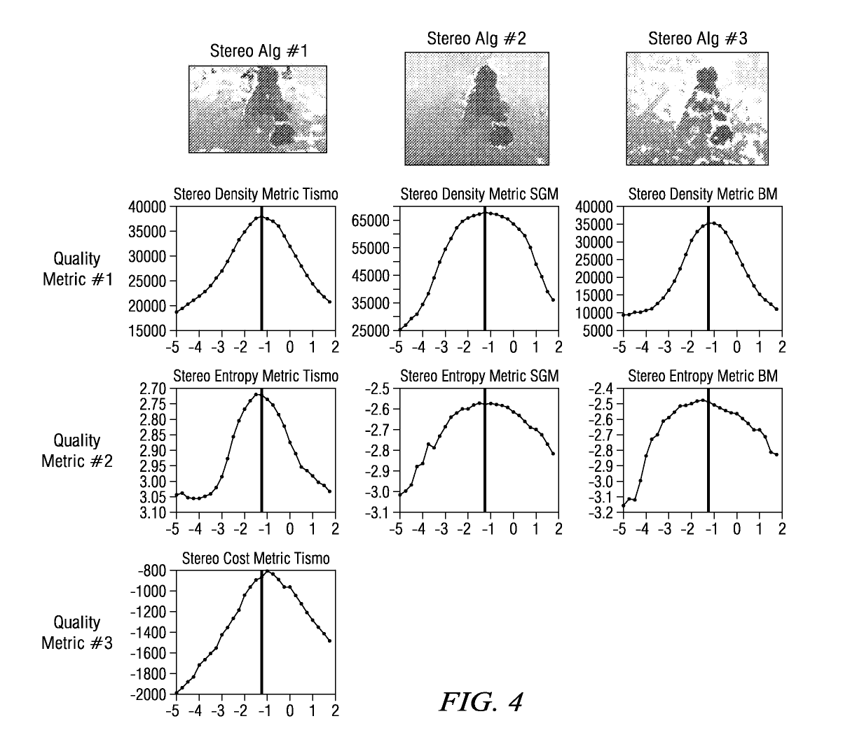

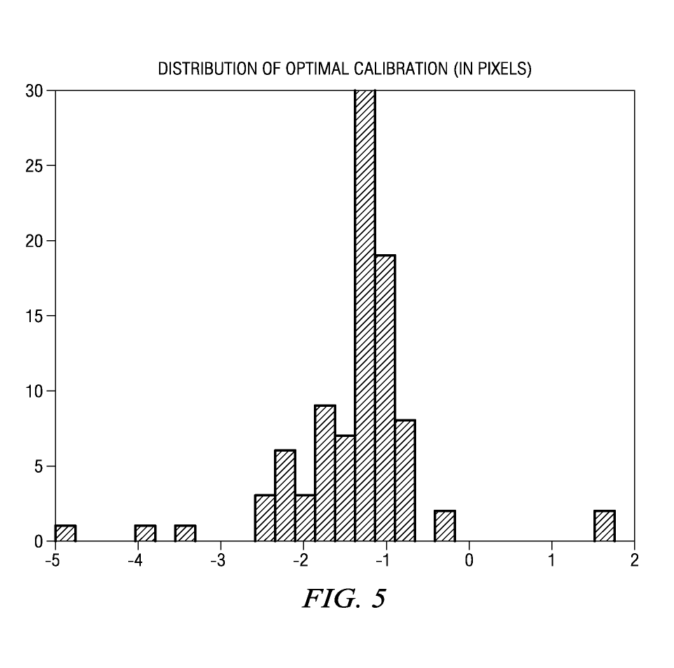

FIG. 4 is an embodiment of three different stereo algorithms using three different quality metrics. In all cases, the same vertical displacement is inferred (up to 0.25 pixel noise), reinforcing the fact that our invention is not specific to one type of algorithms or metric. One may not be able to compute two of the plots because the OpenCV software package does not give access to the raw SAD-cost images. Thus, in FIG. 4, this implementation is applied to three different stereo algorithms using three different quality metrics. In all cases, the same vertical displacement is inferred (up to 0.25 pixel noise); therefore, this implementation is not specific to one type of algorithms or metric. The images are from the Scene #1 of FIG. 3.

The calibration refinement may be executed when needed, e.g., when a stereo camera gets turned on or when the zooming mechanism has been activated. In FIG. 5, we show the histogram of optimal vertical displacement values we have inferred over a set of 92 video sequences collected with a consumer-grade camera over multiple sessions.

Such an implementation has vast uses, such as, when the underlying stereo algorithm is being treated as a black box and the specifics of the stereo solution to implement the calibration refinement are not known, when the stereo algorithm is available as a HW accelerator block, the exact same HW can be reused, which leads to minimal MHz loading on the application processor that would be implementing the calibration refinement; and when the disparity image quality metrics are easy to compute and sometimes already available (e.g., SAD-cost is the most common building block of a stereo disparity algorithm).

While the foregoing is directed to embodiments of the present invention, other and further embodiments of the invention may be devised without departing from the basic scope thereof, and the scope thereof is determined by the claims that follow.

What is claimed is:

1. A method for disparity estimation for a camera calibration, the method comprises:
collecting statistical information from at least one disparity image;
inferring sub-pixel misalignment between a left view and a right view of the camera; and
utilizing the collected statistical information and the inferred sub-pixel misalignment for calibration refinement.

2. The method of claim 1, wherein the camera is at least one of a stereo camera, a camera with multiple lenses or a video camera with one or more lenses.

3. The method of claim 1, wherein the calibration is performed during at least one of a run time calibration and an offline calibration.

4. An image capturing device, comprises:
means for collecting statistical information from at least one disparity image;
means for inferring sub-pixel misalignment between a left view and a right view of the image capturing device; and
means for utilizing the collected statistical information and the inferred sub-pixel misalignment for calibration refinement.

5. The image capturing device of claim 4, wherein the image capturing device is at least one of a stereo camera, a camera with multiple lenses or a video camera with one or more lenses.

6. The image capturing device of claim 4, wherein the calibration is performed during at least one of a run time calibration and an offline calibration.

7. A non-transitory computer readable medium comprising computer instruction, when executed, perform a method, the method comprises:
collecting statistical information from at least one disparity image;
inferring sub-pixel misalignment between a left view and a right view of the camera; and
utilizing the collected statistical information and the inferred sub-pixel misalignment for calibration refinement.

8. The non-transitory computer readable medium of claim 7, wherein computer instructions manipulate data from at least one of one lense of multiple lenses.

9. The non-transitory computer readable medium of claim 7, wherein the calibration is performed during at least one of a run time calibration and an offline calibration.
